(19) United States
(12) Patent Application Publication
(10) Pub. No.: US 2020/0084794 A1
(43) Pub. Date: Mar. 12, 2020

(54) Resource Indication and Reception Methods and Apparatuses and Communication System

(71) Applicant: FUJITSU LIMITED, Kawasaki-shi (JP)

(72) Inventors: Guoyu ZHANG, Beijing (CN); Lei SONG, Beijing (CN); Xin WANG, Beijing (CN)

(73) Assignee: FUJITSU LIMITED, Kawasaki-shi (JP)

(21) Appl. No.: 16/682,550

(22) Filed: Nov. 13, 2019

Related U.S. Application Data
(63) Continuation of application No. PCT/CN2017/096885, filed on Aug. 10, 2017.

(51) Int. Cl. H04W 72/12; H04L 5/00; H04W 24/10

(52) U.S. Cl. CPC H04W 72/1289; H04W 72/121; H04W 24/10; H04L 5/0048

(57) ABSTRACT

Resource indication and reception methods and apparatuses and a communication system. The resource indication method includes: transmitting common signaling used for indicating channel state information reference signal resources to a group including a plurality of user equipments; and transmitting specific signaling of one or more UEs in the group used for scheduling downlink data and/or indicating channel state information measurement.

### CROSS REFERENCE TO RELATED APPLICATIONS

This application is a continuation application of International Application PCT/CN2017/096885 filed on Aug. 10, 2017, the entire contents of which are incorporated herein by reference.

### TECHNICAL FIELD

This disclosure relates to the field of communication technologies, and in particular to resource indication and reception methods and apparatuses and a communication system.

### BACKGROUND

In a long term evolution (LTE) system, a network equipment (for example, a base station) may transmit downlink data to a user equipment (UE), and when data symbols of a physical downlink shared channel (PDSCH) are mapped onto resource blocks (RBs), resource elements (REs) occupied by other physical channels and/or reference signals need to be avoided. Moreover, the network equipment needs to inform the UE of positions of the occupied REs via configuration signaling or an indication signal, so that the UE may correctly de-map the data symbols, and correctly perform decoding.

In an LTE-A (LTE-advanced) system, a periodic channel state information reference signal (CSI-RS) is configured by higher layer signaling, such as radio resource control (RRC) signaling. In performing PDSCH mapping, a network equipment may acquire positions and the number of occupied REs according to configuration information, thereby performing rate matching of data symbols.

An aperiodic CSI-RS is configured by RRC signaling and is triggered by downlink control information (DCI). There exist two cases in performing PDSCH rate matching: when the aperiodic CSI-RS a PDSCH are transmitted to the same UE, the rate matching will be performed according to configuration information of the aperiodic CSI-RS of the UE; when the aperiodic CSI-RS and the PDSCH are not transmitted to the same UE, configuration signaling used for performing RE mapping on PDSCHs introduced into LTE Release 11 may be used.

The configuration signaling may configure four zero-power CSI-RSs (ZP CSI-RSs) for the UE, one of ZP CSI-RS resources is indicated by the DCI, and the PDSCH rate matching will avoid the resource occupied by CSI-RSs of other UEs. At this case, the other UEs are also indicated in the received DCI that measurement of the aperiodic CSI occupying the resource is triggered.

It should be noted that the above description of the background is merely provided for clear and complete explanation of this disclosure and for easy understanding by those skilled in the art. And it should not be understood that the above technical solution is known to those skilled in the art as it is described in the background of this disclosure.

### SUMMARY

It was found by the inventors that in the existing resource indication method, the same CSI-RS resource appears in DCI for a UE of which downlink data are scheduled and in DCI for a UE triggering CSI-RS measurement, that is, the same CSI-RS resource takes up a certain amount of overhead in both the DCI. In a fifth generation (5G) communication system, since new radio (NR) supports that a plurality of aperiodic CSI-RS resources appear in the same subframe, a current resource indication method will increase downlink control signaling overhead of the whole system.

Embodiments of this disclosure provide resource indication and reception methods and apparatuses and a communication system, in which it is expected to uniformly configure indication of CSI-RS resources used for PDSCH rate matching and CSI measurement.

According to a first aspect of the embodiments of this disclosure, there is provided a resource indication method, including:

transmitting common signaling used for indicating channel state information reference signal resources by a network equipment to a group including a plurality of user equipments (UEs); and

transmitting specific signaling of one or more UEs in the group used for scheduling downlink data and/or indicating channel state information measurement by the network equipment.

According to a second aspect of the embodiments of this disclosure, there is provided a resource indication apparatus, including:

a common signaling transmitting unit configured to transmit common signaling used for indicating channel state information reference signal resources to a group including a plurality of user equipments (UEs); and

a specific signaling transmitting unit configured to transmit specific signaling of one or more UEs in the group used for scheduling downlink data and/or indicating channel state information measurement.

According to a third aspect of the embodiments of this disclosure, there is provided a resource reception method, including:

receiving, by a UE, common signaling of a group including a plurality of UEs used for indicating channel state information reference signal resources and transmitted by a network equipment; wherein the common signaling is decoded by the UEs in the group; and

receiving, by the UE, specific signaling used for scheduling downlink data and/or indicating channel state information measurement transmitted by the network equipment.

According to a fourth aspect of the embodiments of this disclosure, there is provided a resource reception apparatus, including:

a common signaling receiving unit configured to receive common signaling of a group including a plurality of UEs used for indicating channel state information reference signal resources and transmitted by a network equipment; wherein, the common signaling is decoded by the UEs in the group; and

a specific signaling receiving unit configured to receive specific signaling used for scheduling downlink data and/or indicating channel state information measurement transmitted by the network equipment.

According to a fifth aspect of the embodiments of this disclosure, there is provided a communication system, including:

a network equipment, including the resource indication apparatus as described in the second aspect; and

a UE, including the resource reception apparatus as described in the fourth aspect.

An advantage of the embodiments of this disclosure exists in that the network equipment transmits the common signaling of a UE group used for indicating channel state information reference signal resources, and transmits specific signaling of one or more UEs used for scheduling downlink data and/or indicating channel state information measurement.

Hence, resources used for PDSCH rate matching and CSI measurement are uniformly configured via a high layer, which may simplify description of high layer configuration information; common information of the UE group is indicated via the common signaling, which may efficiently lower control signaling overhead of the whole system; and furthermore, with the common signaling, indication of CSI-RS resources used for PDSCH rate matching and triggering of the CSI-RS are achieved.

With reference to the following description and drawings, the particular embodiments of this disclosure are disclosed in detail, and the principle of this disclosure and the manners of use are indicated. It should be understood that the scope of the embodiments of this disclosure is not limited thereto. The embodiments of this disclosure contain many alternations, modifications and equivalents within the scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “comprise/include” when used in this specification is taken to specify the presence of stated features, integers, steps or components but does not preclude the presence or addition of one or more other features, integers, steps, components or groups thereof.

### BRIEF DESCRIPTION OF THE DRAWINGS

Elements and features depicted in one drawing or embodiment of the disclosure may be combined with elements and features depicted in one or more additional drawings or embodiments. Moreover, in the drawings, like reference numerals designate corresponding parts throughout the several views and may be used to designate like or similar parts in more than one embodiment.

FIG. 1 is a schematic diagram of a communication system of an embodiment of this disclosure;

FIG. 2 is a schematic diagram of the resource reception method of an embodiment of this disclosure;

FIG. 3 is a schematic diagram of the resource indication and reception method of an embodiment of this disclosure;

FIG. 4 is a schematic diagram of a common resource pool configured for a UE group;

FIG. 5 is a schematic diagram of the resource indication method of an embodiment of this disclosure;

FIG. 6 is a schematic diagram of the resource reception apparatus of an embodiment of this disclosure;

FIG. 7 is a schematic diagram of the resource transmission apparatus of an embodiment of this disclosure;

FIG. 8 is a schematic diagram of a network equipment of an embodiment of this disclosure;

and

FIG. 9 is a schematic diagram of a user equipment of an embodiment of this disclosure.

### DETAILED DESCRIPTION

These and further aspects and features of this disclosure will be apparent with reference to the following description and attached drawings. In the description and drawings, particular embodiments of the disclosure have been disclosed in detail as being indicative of some of the ways in which the principles of the disclosure may be employed, but it is understood that the disclosure is not limited correspondingly in scope. Rather, the disclosure includes all changes, modifications and equivalents coming within the terms of the appended claims.

In the embodiments of this disclosure, terms “first”, and “second”, etc., are used to differentiate different elements with respect to names, and do not indicate spatial arrangement or temporal orders of these elements, and these elements should not be limited by these terms. Terms “and/or” include any one and all combinations of one or more relevantly listed terms. Terms “contain”, “include” and “have” refer to existence of stated features, elements, components, or assemblies, but do not exclude existence or addition of one or more other features, elements, components, or assemblies.

In the embodiments of this disclosure, single forms “a”, and “the”, etc., include plural forms, and should be understood as “a kind of” or “a type of” in a broad sense, but should not defined as a meaning of “one”; and the term “the” should be understood as including both a single form and a plural form, except specified otherwise. Furthermore, the term “according to” should be understood as “at least partially according to”, the term “based on” should be understood as “at least partially based on”, except specified otherwise.

In the embodiments of this disclosure, the term “communication network” or “wireless communication network” may refer to a network satisfying any one of the following communication standards: long term evolution (LTE), long term evolution-advanced (LTE-A), wideband code division multiple access (WCDMA), and high-speed packet access (HSPA), etc.

And communication between devices in a communication system may be performed according to communication protocols at any stage, which may, for example, include but not limited to the following communication protocols: 1G (generation), 2G 2.5G 2.75G 3G 4G 4.5G and 5G and new radio (NR) in the future, and/or other communication protocols that are currently known or will be developed in the future.

In the embodiments of this disclosure, the term “network equipment”, for example, refers to equipment in a communication system that accesses terminal equipment to the communication network and provides services for the terminal equipment. The network equipment may include but not limited to the following equipment: a base station (BS), an access point (AP), a transmission reception point (TRP), a broadcast transmitter, a mobile management entity (MME), a gateway, a server, a radio network controller (RNC), a base station controller (BSC).

The base station may include but not limited to a node B (NodeB or NB), an evolved node B (eNodeB or eNB), and a 5G base station (gNB). Furthermore, it may include a remote radio head (RRH), a remote radio unit (RRU), a relay, or a low-power node (such as a femto, and a pico). The term “base station” may include some or all of its functions, and each base station may provide communication coverage for a specific geographical area. And a term “cell” may refer to a base station and/or its coverage area, which is dependent on a context of the term.

In the embodiments of this disclosure, the term “user equipment (UE)” or “terminal equipment (TE)” refers to, for example, equipment accessing to a communication network and receiving network services via a network equipment. The user equipment may be fixed or mobile, and may also be referred to as a mobile station (MS), a terminal, a subscriber station (SS), an access terminal (AT), or a station, etc.

The user equipment may include but not limited to the following devices: a cellular phone, a personal digital assistant (PDA), a wireless modem, a wireless communication device, a hand-held device, a machine-type communication device, a lap-top, a cordless telephone, a smart cell phone, a smart watch, and a digital camera.

For another example, in a scenario of the Internet of Things (IoT), etc., the user equipment may also be a machine or a device performing monitoring or measurement. For example, it may include but not limited to a machine-type communication (MTC) terminal, a vehicle mounted communication terminal, a device to device (D2D) terminal, and a machine to machine (M2M) terminal.

Scenarios in the embodiments of this disclosure shall be described below by way of examples; however, this disclosure is not limited thereto.

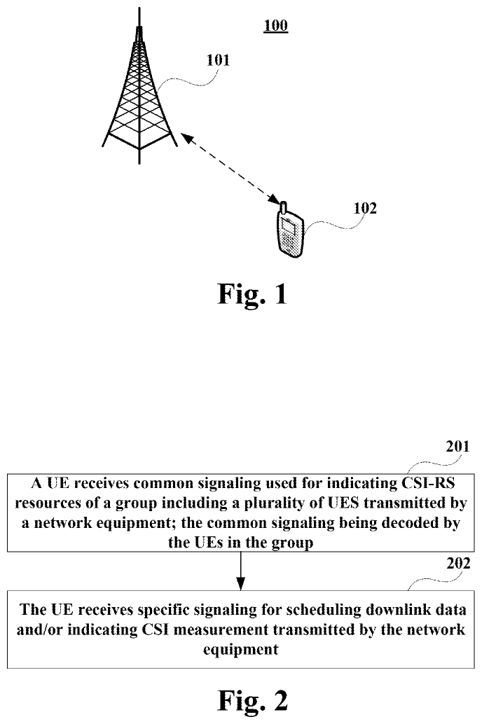

FIG. 1 is a schematic diagram of a communication system of an embodiment of this disclosure, in which a case where user equipment and network equipment are taken as examples is schematically shown. As shown in FIG. 1, a communication system 100 may include a network equipment 101 and a user equipment 102. For the sake of convenience, FIG. 1 schematically gives an example where the number of the network equipment is one and the number of the user equipment is one; however, the embodiment of this disclosure is not limited thereto.

In the embodiment of this disclosure, existing traffics or traffics that may be implemented in the future may be performed between the network equipment 101 and the user equipment 102. For example, such traffics may include but not limited to an enhanced mobile broadband (eMBB), massive machine type communication (MTC), and ultra-reliable and low-latency communication (URLLC).

The embodiments of this disclosure shall be described below by taking an NR system as an example. However, this disclosure is not limited thereto, and it is also applicable to any systems in which similar problems exist. In addition, the embodiments of this disclosure shall be described by taking an aperiodic CSI-RS resource as an example. However, this disclosure is not limited thereto; for example, the methods or apparatuses of this disclosure may also be applicable to other channel measurement or channel estimation resources.

### Embodiment 1

The embodiments of this disclosure provide a resource reception method, which is applicable to a UE side.

FIG. 2 is a schematic diagram of the resource reception method of the embodiment of this disclosure, which shall be described from the UE side. As shown in FIG. 2, the method includes:

201: a UE receives common signaling used for indicating CSI-RS resources of a group including a plurality of user equipments transmitted by a network equipment, the common signaling being decoded by the user equipments in the group; and

202: the UE receives specific signaling for scheduling downlink data and/or indicating CSI measurement transmitted by the network equipment.

It is specified in the NR that transmission of aperiodic CSI-RS resources is triggered by DCI, and emerging aperiodic CSI-RS resources need to be indicated by dynamic signaling in PDSCH rate matching. When an aperiodic CSI-RS resource is transmitted in a PDSCH, not only a UE receiving data needs to be indicated by dynamic signaling one or more REs occupied by the aperiodic CSI-RS resource so as to perform rate matching of the PDSCH, but also a UE receiving a CSI-RS needs to be indicated by dynamic signaling that its aperiodic CSI-RS resource is triggered.

Although such dynamic signaling is used for different purposes (PDSCH rate matching or CSI-RS triggering), it indicates to the UE that CSI-RS resources are transmitted. If the indication information is transmitted in each related UE-specific PDCCH, overall control signaling overhead of the system will be increased. For example, if the indication information needs M bits and N UEs need to receive the indication information, overhead of the indication information in the system signaling will be M*N bits.

In an embodiment, the indication information indicating the aperiodic CSI-RS resources is carried by the common control signaling of the UE group (such as a group common PDCCH), and each UE in the group (i.e. all the UEs in the group; however, this disclosure is not limited thereto) decodes the common signaling, so as to determine whether there exist aperiodic CSI-RS resources that are transmitted. Hence, the indication information of aperiodic CSI-RS resources transmitted to different UEs is combined in one piece of common signaling in the embodiment of this disclosure, which may efficiently lower overall control signaling overhead of the system.

In an embodiment, when the UE performing data reception de-maps downlink data, the UE may avoid the channel state information reference signal resources indicated in the common signaling, so as to perform rate matching on the downlink data. The UE performing CSI measurement may determine according to the specific signaling whether to trigger measurement of the channel state information, and when it is determined that the measurement of the channel state information is triggered, use the channel state information reference signal resources to perform the measurement of the channel state information.

In an embodiment, the common signaling may be carried in a group common PDCCH, and DCI in the group common PDCCH may include information on one or more aperiodic CSI-RS resources. The specific signaling may be carried in a UE-specific PDCCH, and DCI in the UE-specific PDCCH may include indication information of a PDSCH carrying the downlink data and/or acknowledgement information acknowledging to perform aperiodic CSI measurement.

For example, a UE in the group may obtain information on PDSCH mapping rate matching and triggering of aperiodic CSI-RSs in the following two steps.

First step, all UEs in the group decode the group common PDCCH to determine whether there is transmission of an aperiodic CSI-RS resource; if yes, it indicates that an aperiodic CSI-RS on the resource is triggered; in addition, if the aperiodic CSI-RS resource is configured in a resource setting (as described later) of a UE, the UE considers that it is possible that the aperiodic CSI-RS resource is transmitted to itself.

Second step, a UE read a respective UE-specific PDCCH. When it is scheduled with downlink data, de-data mapping will avoid one or more REs occupied by the CSI-RS resources indicated in the first step. In addition, the same resource may be configured for a plurality of UEs. Therefore, a UE of an indicated resource is configured in the resource setting, which may read 1-bit acknowledgement information in the UE-specific PDCCH to determine whether it is itself that needs to use the indicated resources to perform CSI measurement.

In an embodiment, a common resource pool may also be configured for each group and resources may be configured for each UE.

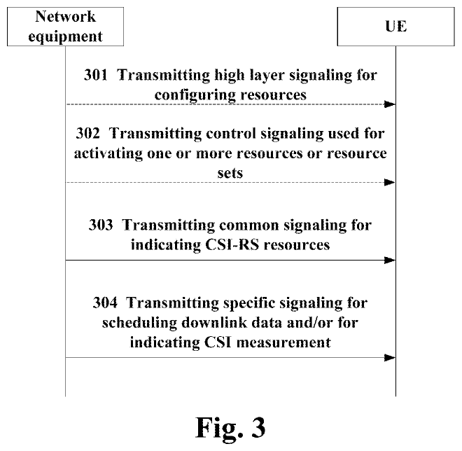

FIG. 3 is another schematic diagram of the resource reception method of the embodiment of this disclosure, which shall be described from the UE side and a network equipment side. As shown in FIG. 3, the method may include:

301: the network equipment transmits to the UE, high layer signaling for configuring resources; UEs in the group are configured with a common resource pool, and each UE is configured with one or more resources or resource sets selected from the resource pool.

The resource pool may include one or more of the following resources: a periodic CSI-RS resource, a semi-persistent CSI-RS resource, and an aperiodic CSI-RS resource.

For example, the network equipment may group the served UEs via high layer signaling (such as RRC signaling), and configure a common CSI-RS resource pool for intra-group UEs (which may be referred to as a pool setting), each CSI-RS resource in the pool being configured with different parameters (such as a density, the number of antenna ports, and an RE resource pattern.). In addition, the parameters of the CSI measurement (which may be referred to as a resource setting) may be configured for each UE, and resources of each UE may be selected from the resource pool.

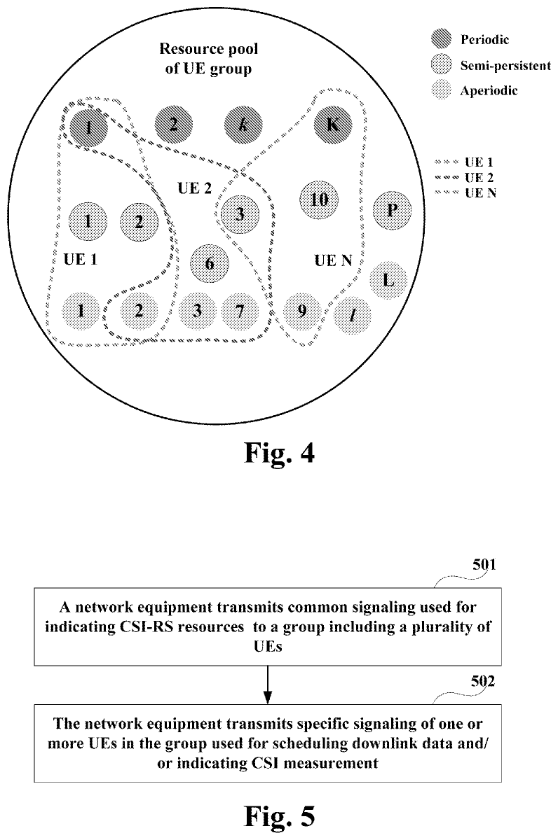

FIG. 4 is a schematic diagram of a common resource pool configured for a UE group. As shown in FIG. 4, in a pool setting, resources may be respectively numbered according to different periodicities (including, for example, periodic, semi-persistent, and aperiodic).

As shown in FIG. 4, a periodic resource 1, semi-persistent resources 3 and 6 and aperiodic resources 2, 3 and 7, in the resource pool, are selected in a resource setting of UE 2, and these resources may be configured for UE 2 for use in CSI measurement. And for each UE, it may know from the resource setting which resources in the resource pool are used for CSI measurement, but it does not need to know which resources are configured for other UEs for CSI measurement.

Table 1 shows an example of resource configurations for the CSI measurement by respective UEs in FIG. 4.

TABLE 1

| | Periodic | Semi-persistent | Aperiodic |
|---|---|---|---|
| UE 1 | 1 | 1, 2 | 1, 2 |
| UE 2 | 1 | 3, 6 | 2, 3, 7 |
| UE N | K | 3, 10 | 9 |

For all UEs in a group, if the CSI-RS resources in a resource pool occur on PDSCHs transmitting downlink data of the UEs, data mapping of the UEs needs to avoid REs occupied by these resources, no matter whether the CSI-RS resources are transmitted to the UEs.

As shown in FIG. 3, the method may further include:

302: the network equipment transmits control signaling used for activating one or more resources or resource sets configured by the high-layer signaling to the UE; the control signaling may be, for example, a medium access control (MAC) control element; however, this disclosure is not limited thereto;

303: the network equipment transmits common signaling for indicating CSI-RS resources to the UEs in the group.

In an embodiment, DCI in the common signaling may include: a bitmap field indicating the aperiodic CSI-RS resources, each bit or each multiple bits in the bitmap field corresponding to a resource or resource set of one aperiodic CSI-RS.

That is, in order to achieve simultaneous indication of a plurality of CSI-RS resources, the indication information may be designed as being in a form of a bitmap, and each bit of the bitmap indicates whether a resource/resource set is transmitted. For example, ‘0’ denotes that it is not transmitted and ‘1’ denotes that it is transmitted. Moreover, according to different purposes for measurement, one time of measurement may possibly trigger a plurality of resources at the same time. For example, in beam management, a plurality of aperiodic CSI-RS resources may possibly be triggered at the same time. Hence, one bit in the bitmap may possibly indicate a resource set.

For example, suppose that the resource pool in FIG. 4 contains nine aperiodic CSI-RS resources; resources 3 and 7 belong to one resource set, and resources 4, 5, and 6 belong to another resource set, and they are always scheduled in a form of resource set. Therefore, both bits 3 and 4 in a 6-bit bitmap indicate whether a resource set is present or not.

Table 2 shows an example of a bitmap containing aperiodic CSI-RS indication information.

TABLE 2

| | Bitmap | | | | | |
|---|---|---|---|---|---|---|
| | 1 | 2 | 3 | 4 | 5 | 6 |
| Numbers of aperiodic resources | 1 | 2 | 3, 7 | 4, 5, 6 | 8 | 9 |
| in the resource pool | | | | | | |

However, an issue of overhead needs to be taken into account in the group common PDCCH. When the number of aperiodic resources configured in the resource pool is relatively large, bitmap occupation overhead will be increased, which will affect coverage of the group common PDCCH. Therefore, it may be taken into account that a certain number of resources or resource sets in the resource pool are activated by the MAC CE in 302, and the triggered resources or resource sets are indicated by a bitmap in the group common PDCCH. The number of bits in the bitmap is identical to the number of activated resources or resource sets.

For example, in a group common PDCCH, a 6-bit bitmap indicates aperiodic resources, and when the number of aperiodic resources or resource sets in the resource pool is greater than six, 6 of them are activated by MAC CE signaling, and then the bitmap in the group common PDCCH indicates a triggering situation; and when the number of aperiodic resources or the resource sets is less than or equal to 6, the activation of the MAC CE in 302 may be skipped over, and the bitmap is directly used for indication.

304: the network equipment transmits specific signaling for scheduling downlink data and/or for indicating channel state information measurement respectively to one or more UEs.

It should be appreciated that the embodiment of this disclosure is only illustrated in FIG. 3; however, this disclosure is not limited thereto. For example, an order of execution of the operations may be appropriately adjusted, and furthermore, some other operations may be added, or some operations therein may be reduced. And appropriate variants may be made by those skilled in the art according to the above contents, without being limited to what is contained in FIG. 3.

As can be seen from the above embodiments, the network equipment transmits the common signaling of the UE group for indicating the channel state information reference signal resources, and transmits the specific signaling of one or more UEs for scheduling downlink data and/or for indicating channel state information measurement.

Hence, the resources for PDSCH rate matching and CSI measurement may be uniformly configured via a high layer, and the description of the high-layer configuration information may be simplified. And by indicating the common information of the group via the common signaling, the control signaling overhead of the whole system may be efficiently lowered, such as when a PDSCH carries a plurality of CSI-RS resources and the PDSCH is in a transmission mode of MU-MIMO. Furthermore, with the common signaling, indication of the CSI-RS resources used for PDSCH rate matching and triggering of CSI-RSs may be implemented.

### Embodiment 2

The embodiments of this disclosure provide a resource indication method, which is applicable to a network equipment side, with contents in these embodiments identical to those in Embodiment 1 being not going to be described herein any further.

FIG. 5 is a schematic diagram of the resource indication method of the embodiment of this disclosure, which shall be described from the network equipment side. As shown in FIG. 5, the method includes:

501: the network equipment transmits common signaling used for indicating channel state information reference signal resources to a group including a plurality of UEs; and

502: the network equipment transmits specific signaling of one or more UEs in the group used for scheduling downlink data and/or indicating channel state information measurement.

In an embodiment, the channel state information reference signal resources may be used by the UE for performing rate matching on the downlink data, and/or the channel state information reference signal resources may be used by the UE for performing the channel state information measurement.

In an embodiment, the common signaling may be carried in a group common physical downlink control channel, downlink control information in the group common physical downlink control channel including information indicating one or more aperiodic channel state information reference signal resources.

For example, the downlink control information includes a bitmap field indicating the aperiodic channel state information reference signal resources, each bit or each multiple bits in the bitmap field corresponding to a resource or resource set of one aperiodic channel state information reference signal.

In an embodiment, the specific signaling may be carried in a UE-specific physical downlink control channel, downlink control information in the UE-specific physical downlink control channel including indication information of a physical downlink shared channel carrying the downlink data and/or acknowledgement information acknowledging to perform measurement of aperiodic channel state information.

In an embodiment, the network equipment may further transmit high-layer signaling used for configuring resources to the UEs in the group; the UEs in the group are configured with a common resource pool, each UE being configured with one or more resources or resource sets selected from the resource pool.

For example, the resource pool includes one or more of the following resources: a periodic channel state information reference signal resource, a semi-persistent channel state information reference signal resource and an aperiodic channel state information reference signal resource.

In an embodiment, the network equipment may further transmit control signaling used for activating one or more resources or resource sets configured by the high-layer signaling to the UE.

As can be seen from the above embodiments, the network equipment transmits the common signaling of the UE group for indicating the channel state information reference signal resources, and transmits the specific signaling of one or more UEs for scheduling downlink data and/or for indicating channel state information measurement.

Hence, the resources for PDSCH rate matching and CSI measurement may be uniformly configured via a high layer, and the description of the high-layer configuration information may be simplified. And by indicating the common information of the group via the common signaling, the control signaling overhead of the whole system may be efficiently lowered, such as when a PDSCH carries a plurality of CSI-RS resources and the PDSCH is in a transmission mode of MU-MIMO. Furthermore, with the common signaling, indication of the CSI-RS resources used for PDSCH rate matching and triggering of CSI-RSs may be implemented.

### Embodiment 3

The embodiments of this disclosure provide a resource reception apparatus, which may be, for example, a UE, or one or more components or assemblies configured in a UE, with contents in these embodiments identical to those in Embodiment 1 being not going to be described herein any further.

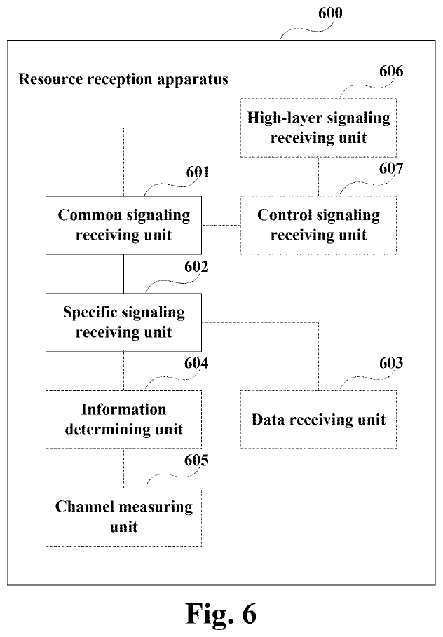

FIG. 6 is a schematic diagram of the resource reception apparatus of the embodiment of this disclosure. As shown in FIG. 6, a resource reception apparatus 600 includes:

a common signaling receiving unit 601 configured to receive common signaling of a group including a plurality of UEs used for indicating channel state information reference signal resources and transmitted by a network equipment; the common signaling is decoded by the UEs in the group; and

a specific signaling receiving unit 602 configured to receive specific signaling used for scheduling downlink data and/or indicating channel state information measurement transmitted by the network equipment.

As shown in FIG. 6, the resource reception apparatus 600 may further include:

a data receiving unit 603 configured to avoid the channel state information reference signal resources indicated by the common signaling in de-mapping the downlink data, to perform rate matching on the downlink data.

As shown in FIG. 6, the resource reception apparatus 600 may further include:

an information determining unit 604 configured to determine whether to trigger the channel state information measurement according to the specific signaling; and

a channel measuring unit 605 configured to perform the channel state information measurement by using the channel state information reference signal resources when it is determined that the channel state information measurement is triggered.

As shown in FIG. 6, the resource reception apparatus 600 may further include:

a high-layer signaling receiving unit 606 configured to receive high-layer signaling used for configuring resources and transmitted by the network equipment; the UEs in the group are configured with a common resource pool, and each UE being configured with one or more resources or resource sets selected from the resource pool.

As shown in FIG. 6, the resource reception apparatus 600 may further include:

a control signaling receiving unit 607 configured to receive control signaling transmitted by the network equipment and used for activating one or more resources or resource sets configured by the high-layer signaling.

It should be appreciated that the components or modules related to this disclosure are only described above; however, this disclosure is not limited thereto. For example, the resource reception apparatus 600 may further include other components or modules, and reference may be made to related techniques for particulars of these components or modules.

As can be seen from the above embodiments, the network equipment transmits the common signaling of the UE group for indicating the channel state information reference signal resources, and transmits the specific signaling of one or more UEs for scheduling downlink data and/or for indicating channel state information measurement.

Hence, the resources for PDSCH rate matching and CSI measurement may be uniformly configured via a high layer, and the description of the high-layer configuration information may be simplified. And by indicating the common information of the group via the common signaling, the control signaling overhead of the whole system may be efficiently lowered, such as when a PDSCH carries a plurality of CSI-RS resources and the PDSCH is in a transmission mode of MU-MIMO. Furthermore, with the common signaling, indication of the CSI-RS resources used for PDSCH rate matching and triggering of CSI-RSs may be implemented.

### Embodiment 4

The embodiments of this disclosure provide a resource indication apparatus, which may be, for example, a network equipment, or one or more components or assemblies configured in a network equipment, with contents in these embodiments identical to those in Embodiment 2 being not going to be described herein any further.

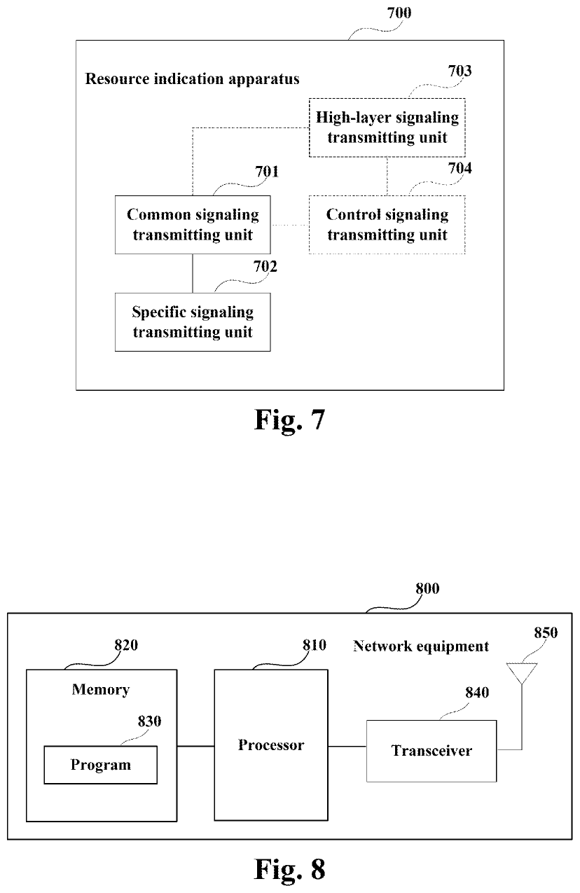

FIG. 7 is a schematic diagram of the resource indication apparatus of the embodiment of this disclosure. As shown in FIG. 7, a resource indication apparatus 700 includes:

a common signaling transmitting unit 701 configured to transmit common signaling used for indicating channel state information reference signal resources to a group including a plurality of UEs; and

a specific signaling transmitting unit 702 configured to transmit specific signaling of one or more UEs in the group used for scheduling downlink data and/or indicating channel state information measurement.

As shown in FIG. 7, the resource indication apparatus 700 may further include:

a high-layer signaling transmitting unit 703 configured to transmit high-layer signaling used for configuring resources to the UEs in the group; the UEs in the group are configured with a common resource pool, each UE being configured with one or more resources or resource sets selected from the resource pool.

As shown in FIG. 7, the resource indication apparatus 700 may further include:

a control signaling transmitting unit 704 configured to transmit control signaling used for activating one or more resources or resource sets configured by the high-layer signaling to the UEs.

It should be appreciated that the components or modules related to this disclosure are only described above; however, this disclosure is not limited thereto. For example, the resource indication apparatus 700 may further include other components or modules, and reference may be made to related techniques for particulars of these components or modules.

As can be seen from the above embodiments, the network equipment transmits the common signaling of the UE group for indicating the channel state information reference signal resources, and transmits the specific signaling of one or more UEs for scheduling downlink data and/or for indicating channel state information measurement.

Hence, the resources for PDSCH rate matching and CSI measurement may be uniformly configured via a high layer, and the description of the high-layer configuration information may be simplified. And by indicating the common information of the group via the common signaling, the control signaling overhead of the whole system may be efficiently lowered, such as when a PDSCH carries a plurality of CSI-RS resources and the PDSCH is in a transmission mode of MU-MIMO. Furthermore, with the common signaling, indication of the CSI-RS resources used for PDSCH rate matching and triggering of CSI-RSs may be implemented.

### Embodiment 5

The embodiments of this disclosure provide a communication system, reference may be made to FIG. 1, with contents identical to those in embodiments 1-4 being not going to be described herein any further. In these embodiments, the communication system 100 may include:

a network equipment 101 configured with the resource indication apparatus 700 described in Embodiment 4; and

a UE 102 configured with the resource reception apparatus 600 described in Embodiment 3.

The embodiment of this disclosure further provides a network equipment, which may be, for example, a base station; however, this disclosure is not limited thereto, and it may also be other network equipment.

FIG. 8 is a schematic diagram of a structure of the network equipment of the embodiment of this disclosure. As shown in FIG. 8, a network equipment 800 may include a processor 810 (such as a central processing unit (CPU)) and a memory 820, the memory 820 being coupled to the processor 810. The memory 820 may store various data, and furthermore, it may store a program 830 for data processing, and execute the program 830 under control of the processor 810.

For example, the processor 810 may be configured to execute the program 830 to carry out the resource indication method described in Embodiment 2. For example, the processor 810 may be configured to perform the following control: transmitting common signaling used for indicating channel state information reference signal resources to a group including a plurality of user equipments; and transmitting specific signaling of one or more UEs in the group used for scheduling downlink data and/or indicating channel state information measurement by the network equipment.

Furthermore, as shown in FIG. 8, the network equipment 800 may include a transceiver 840, and an antenna 850, etc. Functions of the above components are similar to those in the relevant art, and shall not be described herein any further. It should be noted that the network equipment 800 does not necessarily include all the parts shown in FIG. 8, and furthermore, the network equipment 800 may include parts not shown in FIG. 8, and the relevant art may be referred to.

The embodiment of this disclosure further provides a UE; however, it is not limited thereto, and it also may be other equipment.

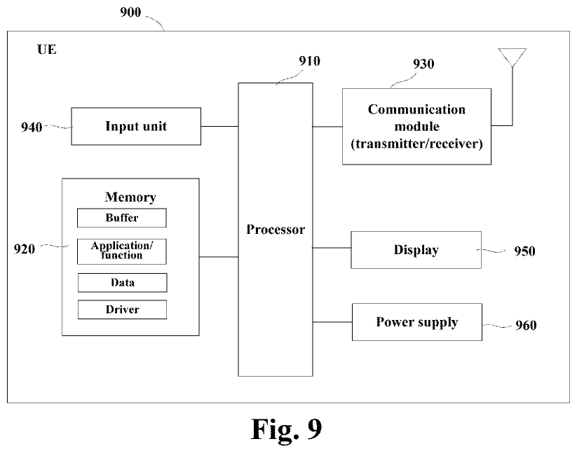

FIG. 9 is a schematic diagram of the UE of the embodiment of this disclosure. As shown in FIG. 9, a UE 900 may include a processor 910 and a memory 920, the memory 920 storing data and a program and being coupled to the processor 910. It should be noted that this figure is illustrative only, and other types of structures may also be used, so as to supplement or replace this structure and achieve a telecommunications function or other functions.

For example, the processor 910 may be configured to execute the program to carry out the resource reception method described in Embodiment 1. For example, the processor 910 may be configured to perform the following control: receiving common signaling of a group including a plurality of UEs used for indicating channel state information reference signal resources and transmitted by a network equipment; the common signaling is decoded by the UEs in the group; and receiving specific signaling used for scheduling downlink data and/or indicating channel state information measurement transmitted by the network equipment.

As shown in FIG. 9, the UE 900 may further include a communication module 930, an input unit 940, a display 950, and a power supply 960; functions of the above components are similar to those in the relevant art, which shall not be described herein any further. It should be noted that the UE 900 does not necessarily include all the parts shown in FIG. 9, and the above components are not necessary; and furthermore, the UE 900 may include parts not shown in FIG. 9, and the relevant art may be referred to.

An embodiment of the present disclosure provides a computer readable program code, which, when executed in a network equipment, may cause the network equipment to carry out the resource indication method as described in Embodiment 2.

An embodiment of the present disclosure provides a computer storage medium, including a computer readable program code, which may cause a network equipment to carry out the resource indication method as described in Embodiment 2.

An embodiment of the present disclosure provides a computer readable program code, which, when executed in a user equipment, may cause the user equipment to carry out the resource reception method as described in Embodiment 1.

An embodiment of the present disclosure provides a computer storage medium, including a computer readable program code, which may cause a user equipment to carry out the resource reception method as described in Embodiment 1.

The above apparatuses and methods of this disclosure may be implemented by hardware, or by hardware in combination with software. The present disclosure relates to such a computer-readable program that when the program is executed by a logic device, the logic device is enabled to carry out the apparatus or components as described above, or to carry out the methods or steps as described above. The present disclosure also relates to a storage medium for storing the above program, such as a hard disk, a floppy disk, a CD, a DVD, and a flash memory.

The methods/apparatuses described with reference to the embodiments of this disclosure may be directly embodied as hardware, software modules executed by a processor, or a combination thereof. For example, one or more functional block diagrams and/or one or more combinations of the functional block diagrams shown in FIG. 6 may either correspond to software modules of procedures of a computer program, or correspond to hardware modules. Such software modules may respectively correspond to the steps shown in FIG. 2. And the hardware module, for example, may be carried out by firming the soft modules by using a field programmable gate array (FPGA).

The soft modules may be located in an RAM, a flash memory, an ROM, an EPROM, and EEPROM, a register, a hard disc, a floppy disc, a CD-ROM, or any memory medium in other forms known in the art. A memory medium may be coupled to a processor, so that the processor may be able to read information from the memory medium, and write information into the memory medium; or the memory medium may be a component of the processor. The processor and the memory medium may be located in an ASIC. The soft modules may be stored in a memory of a mobile terminal, and may also be stored in a memory card of a pluggable mobile terminal. For example, if equipment (such as a mobile terminal) employs an MEGA-SIM card of a relatively large capacity or a flash memory device of a large capacity, the soft modules may be stored in the MEGA-SIM card or the flash memory device of a large capacity.

One or more functional blocks and/or one or more combinations of the functional blocks in the drawings may be realized as a universal processor, a digital signal processor (DSP), an application-specific integrated circuit (ASIC), a field programmable gate array (FPGA) or other programmable logic devices, discrete gate or transistor logic devices, discrete hardware component or any appropriate combinations thereof carrying out the functions described in this application. And the one or more functional block diagrams and/or one or more combinations of the functional block diagrams in the drawings may also be realized as a combination of computing equipment, such as a combination of a DSP and a microprocessor, multiple processors, one or more microprocessors in communication combination with a DSP, or any other such configuration.

This disclosure is described above with reference to particular embodiments. However, it should be understood by those skilled in the art that such a description is illustrative only, and not intended to limit the protection scope of the present disclosure. Various variants and modifications may be made by those skilled in the art according to the principle of the present disclosure, and such variants and modifications fall within the scope of the present disclosure.

For implementations of this disclosure containing the above embodiments, following supplements are further disclosed.

Supplement 1. A resource reception method, including:

receiving common signaling of a group including a plurality of UEs used for indicating channel state information reference signal resources and transmitted by a network equipment; wherein the common signaling is decoded by the UEs in the group; and

receiving specific signaling used for scheduling downlink data and/or indicating channel state information measurement transmitted by the network equipment.

Supplement 2. The method according to supplement 1, wherein the method further includes:

avoiding the channel state information reference signal resources indicated by the common signaling in de-mapping the downlink data, to perform rate matching on the downlink data.

Supplement 3. The method according to supplement 1, wherein the method further includes:

determining whether to trigger the channel state information measurement according to the specific signaling; and

performing the channel state information measurement by using the channel state information reference signal resources when it is determined that the channel state information measurement is triggered.

Supplement 4. The method according to supplement 1, wherein the common signaling is carried in a group common physical downlink control channel, downlink control information in the group common physical downlink control channel including information indicating one or more aperiodic channel state information reference signal resources.

Supplement 5. The method according to supplement 4, wherein the downlink control information includes a bitmap field indicating the aperiodic channel state information reference signal resources, each bit or each multiple bits in the bitmap field corresponding to a resource or resource set of one aperiodic channel state information reference signal.

Supplement 6. The method according to supplement 1, wherein the specific signaling is carried in a UE-specific physical downlink control channel, downlink control information in the UE-specific physical downlink control channel including indication information of a physical downlink shared channel carrying the downlink data and/or acknowledgement information acknowledging to perform measurement of aperiodic channel state information.

Supplement 7. The method according to supplement 1, wherein the method further includes:

receiving high-layer signaling used for configuring resources transmitted by the network equipment; and wherein the UEs in the group are configured with a common resource pool, each UE being configured with one or more resources or resource sets selected from the resource pool.

Supplement 8. The method according to supplement 1, wherein the resource pool includes one or more of the following resources: a periodic channel state information reference signal resource, a semi-persistent channel state information reference signal resource and an aperiodic channel state information reference signal resource.

Supplement 9. The method according to supplement 7, wherein the method further includes: receiving control signaling used for activating one or more resources or resource sets configured by the high-layer signaling transmitted by the network equipment.

Supplement 10. A resource indication method, including:

transmitting common signaling used for indicating channel state information reference signal resources to a group including a plurality of UEs; and

transmitting specific signaling of one or more UEs in the group used for scheduling downlink data and/or indicating channel state information measurement. Supplement 11. The method according to supplement 10, wherein the channel state information reference signal resources are used by a UE for performing rate matching on the downlink data, and/or the channel state information reference signal resources are used by a UE for performing the channel state information measurement.

Supplement 12. The method according to supplement 10, wherein the common signaling is carried in a group common physical downlink control channel, downlink control information in the group common physical downlink control channel including information indicating one or more aperiodic channel state information reference signal resources.

Supplement 13. The method according to supplement 12, wherein the downlink control information includes a bitmap field indicating the aperiodic channel state information reference signal resources, each bit or each multiple bits in the bitmap field corresponding to a resource or resource set of one aperiodic channel state information reference signal.

Supplement 14. The method according to supplement 10, wherein the specific signaling is carried in a UE-specific physical downlink control channel, downlink control information in the UE-specific physical downlink control channel including indication information of a physical downlink shared channel carrying the downlink data and/or acknowledgement information acknowledging to perform measurement of aperiodic channel state information.

Supplement 15. The method according to supplement 10, wherein the method further includes:

transmitting high-layer signaling used for configuring resources to the UEs in the group; and wherein the UEs in the group are configured with a common resource pool, each UE being configured with one or more resources or resource sets selected from the resource pool.

Supplement 16. The method according to supplement 15, wherein the resource pool includes one or more of the following resources: a periodic channel state information reference signal resource, a semi-persistent channel state information reference signal resource and an aperiodic channel state information reference signal resource.

Supplement 17. The method according to supplement 15, wherein the method further includes:

transmitting control signaling used for activating one or more resources or resource sets configured by the high-layer signaling to a UE.

What is claimed is:

1. A resource indication apparatus, comprising:
a memory that stores a plurality of instructions; and
a processor coupled to the memory and configured to execute the instructions to:
transmit common signaling used for indicating channel state information reference signal resources to a group comprising a plurality of user equipments (UEs); and
transmit specific signaling of one or more UEs in the group used for scheduling downlink data and/or indicating channel state information measurement.

2. The apparatus according to claim 1, wherein the channel state information reference signal resources are used by a UE for performing rate matching on the downlink data, and/or the channel state information reference signal resources are used by a UE for performing the channel state information measurement.

3. The apparatus according to claim 1, wherein the common signaling is carried in a group common physical downlink control channel, downlink control information in the group common physical downlink control channel comprising information indicating one or more aperiodic channel state information reference signal resources.

4. The apparatus according to claim 3, wherein the downlink control information comprises a bitmap field indicating the aperiodic channel state information reference signal resources, each bit or each multiple bits in the bitmap field corresponding to a resource or resource set of one aperiodic channel state information reference signal.

5. The apparatus according to claim 1, wherein the specific signaling is carried in a UE-specific physical downlink control channel, downlink control information in the UE-specific physical downlink control channel comprising indication information of a physical downlink shared channel carrying the downlink data and/or acknowledgement information acknowledging to perform measurement of aperiodic channel state information.

6. The apparatus according to claim 1, wherein the processor is further configured to execute the instructions to transmit high-layer signaling used for configuring resources to the UEs in the group; and wherein the UEs in the group are configured with a common resource pool, each UE being configured with one or more resources or resource sets selected from the resource pool.

7. The apparatus according to claim 6, wherein the resource pool comprises one or more of the following resources: a periodic channel state information reference signal resource, a semi-persistent channel state information reference signal resource and an aperiodic channel state information reference signal resource.

8. The apparatus according to claim 6, wherein the processor is further configured to execute the instructions to transmit control signaling used for activating one or more resources or resource sets configured by the high-layer signaling to a UE.

9. A resource reception apparatus, comprising:
a memory that stores a plurality of instructions; and
a processor coupled to the memory and configured to execute the instructions to:
receive common signaling of a group comprising a plurality of UEs used for indicating channel state information reference signal resources and transmitted by a network equipment; wherein, the common signaling is decoded by the UEs in the group; and
receive specific signaling used for scheduling downlink data and/or indicating channel state information measurement transmitted by the network equipment.

10. The apparatus according to claim 9, wherein the processor is further configured to execute the instructions to
avoid the channel state information reference signal resources indicated by the common signaling in de-mapping the downlink data, to perform rate matching on the downlink data.

11. The apparatus according to claim 9, wherein the processor is further configured to execute the instructions to
determine whether to trigger the channel state information measurement according to the specific signaling; and
perform the channel state information measurement by using the channel state information reference signal resources when it is determined that the channel state information measurement is triggered.

12. The apparatus according to claim 9, wherein the common signaling is carried in a group common physical downlink control channel, and downlink control information in the group common physical downlink control channel comprising information indicating one or more aperiodic channel state information reference signal resources.

13. The apparatus according to claim 12, wherein the downlink control information comprises a bitmap field indicating the aperiodic channel state information reference signal resources, each bit or each multiple bits in the bitmap field corresponding to a resource or resource set of one aperiodic channel state information reference signal.

14. The apparatus according to claim 9, wherein the specific signaling is carried in a UE-specific physical downlink control channel, and downlink control information in the UE-specific physical downlink control channel comprising indication information of a physical downlink shared channel carrying the downlink data and/or acknowledgement information acknowledging to perform measurement of aperiodic channel state information.

15. The apparatus according to claim 9, wherein the processor is further configured to execute the instructions to
receive high-layer signaling used for configuring resources and transmitted by the network equipment; and wherein the UEs in the group are configured with a common resource pool, and each UE being configured with one or more resources or resource sets selected from the resource pool.

16. The apparatus according to claim 15, wherein the resource pool comprises one or more of the following resources: a periodic channel state information reference signal resource, a semi-persistent channel state information reference signal resource and an aperiodic channel state information reference signal resource.

17. The apparatus according to claim 15, wherein the processor is further configured to execute the instructions to
receive control signaling transmitted by the network equipment and used for activating one or more resources or resource sets configured by the high-layer signaling.

18. A communication system, comprising:
a network equipment, configured to transmit common signaling used for indicating channel state information reference signal resources to a group comprising a plurality of user equipments (UEs); and transmit specific signaling of one or more UEs in the group used for scheduling downlink data and/or indicating channel state information measurement; and
a UE, configured to receive the common signaling and the specific signaling.
